(19) United States
(12) Patent Application Publication
(10) Pub. No.: US 2014/0222604 A1
(43) Pub. Date: Aug. 7, 2014

(54) SYSTEM FOR INTEGRATING ECOMMERCE WEBSITE AND SOCIAL NETWORKING WEBSITE ON A SINGLE WEB-BASED PLATFORM

(71) Applicant: Jaya Bharadwaj Yellapragada, Secunderabad (IN)

(72) Inventor: Jaya Bharadwaj Yellapragada, Secunderabad (IN)

(21) Appl. No.: 14/169,524

(22) Filed: Jan. 31, 2014

(30) Foreign Application Priority Data
Feb. 1, 2013 (IN) 455/CHE/2013

(51) Int. Cl. G06Q 30/06; G06Q 50/00

(52) U.S. Cl. CPC G06Q 30/0601; G06Q 50/01
USPC 705/26.1

(57) ABSTRACT

The present invention relates to a system for integrating ecommerce and social networking site on a single web-based platform, wherein web-programs/applications can be developed using a web-application development framework. Specifically, the present invention relates to a system for connecting buyers, sellers/retailers and users sharing common interest related to products and services via an integrated communication platform. The web-application acts as an intermediary that aggregates users digital activities and provides them with a secured and ubiquitous reserve for personal content. More specifically, the system facilitates retailers or organizations having a database of information to extend their functionality and accessibility to the web-programmed/application framework and deploy and integrate web-applications using developers, thereafter enabling end-users of the framework to avail the information without being required to navigate to multiple web programs/applications or navigate to different websites. Further the system integrates catalogue display, virtual store customizations and implements software development frameworks on the web.

### FIELD OF INVENTION

The present invention relates to a system for integrating ecommerce and social networking site on a single web-based platform, wherein web-programs/applications can be developed using a web-application development framework. Specifically, the present invention relates to a system for connecting buyers, sellers/retailers and users sharing common interest related to products and services via an integrated communication platform. More specifically, the system facilitates retailers or organizations having a database of information to extend their functionality and accessibility to the web-programmed/application framework and deploy and integrate web-applications using developers, thereafter enabling end-users of the framework to avail the information without being required to navigate to multiple web programs/applications or navigate to different websites. The system enables users to communicate effectively with other users and retailers on the communication platform.

### BACKGROUND ART

With growing popularity of the Internet, consumers can freely access information and exchange opinions on products and services online. User of a website is able to gather information about a product or service of interest based on reviews from previous buyers. Retailers are also able to gather information and feedback on their respective product or service through the Internet. Nowadays, users or consumers use search engines to compare product features and prices before making a purchase. Using Internet users can also gather and create product related content such as articles/blog posts, pictures, videos, audio, text media or reviews on social networking, ecommerce websites and niche content-specific websites.

However, search engines, ecommerce and social networking websites function independently of each other and consumers have to access different websites to gain information and review feedback before making a purchase. Moreover, user reviews cannot always be trusted due to source/credibility of information. Often a user is likely to turn to a family or friend for opinion and suggestions before making a decision on purchase. If a user recommends any product or service to his or her friends or family via the social networking websites or shares information regarding it, the retailers on ecommerce websites may not have firsthand access to the recommendations and thoughts posted by the user on the social-networking-site or blog entries. This increases time involved in understating customers and distribution channels of a retailer, and hence the retailer may miss an opportunity to target those specific and targeted prospective customers. Additionally, users may not feel comfortable or secure enough in sharing commerce related information on online platforms, including social networking websites. In addition, this kind of user behavior gives rise to opportunity for various retailers/organizations to use different methods that are more sophisticated and complex to gather feedback and underscores the need for platform that enables more number of users to give feedback and share information relating to products and services.

Various integrated ecommerce and social networking websites on a single web based platform with service providers and virtual retail stores have been devised in the art, some of the measures are as follows:

U.S. Pat. No. 8,306,874 relates to selling method and system that allows individuals or groups to select products and services from a pool of partner e-commerce retailers or imports them from their purchasing histories based on personal preference and may use them for online services. This provides e-commerce retailers with self-selected targeted marketing and referral selling to affinity groups, the online version of word of mouth selling.

US20130073389 relates to online system, methods and computer related aspects of providing broad and alternative categories, especially virtual retail store services that provide users, members and business owners with an online retail store and ability to create a central shopping location where buyers can learn about user and all the products that user sell.

US20120158546 relates to a method for identifying an article of commerce with a portable mobile device and linking the article to a social networking website.

US20120109777 relates to a computer system, for creating and maintaining customized online stores, using a network to customize products offered by selecting from a library of customizing components and applying the components to products. The user can purchase their customized products and/or create an online store to offer and sell their customized products to others.

US20090132365 relates to transaction and advertising platforms with customization of advertizing or search services for individual(s) and group(s) of user(s).

US20080172344 relates to social networking infrastructure and associated e-commerce sites or platforms and in particular to a social networking platform for consolidating tiered vertical market space by connecting multiple vendors to target audiences through an affiliate network.

WO2013069009 disclosure relates to online shops operating over a computer network, where user can sell products through social channel and also through a virtual store operating over the computer network.

Further known prior art is a method to access user generated content which is trusted by internet users. In the said method, information is fetched from different sources but this result in uncertainty of reliable information. Another prior art discloses a method for connecting wish lists to users and making the wish lists accessible to the user. Also existing in prior art is a method for increasing the utility of electronic wish lists and for assisting users in making purchases.

Accordingly, there exists a need for a single web-based communication platform where users can purposely interact and exchange information particularly relating to products or services. Various other features of the system of the present invention will become obvious to those skilled in the art upon reading the disclosure set forth hereinafter.

### OBJECTS OF INVENTION

One or more of the problems of the conventional prior art may be overcome by various embodiments of the system of the present invention.

Accordingly, the primary object of the present invention is to provide a system for integrating ecommerce and social networking site on a single web-based platform wherein web-programs/applications can be developed by using a web-application development framework.

It is another object of the present invention is to provide a system for connecting users via an integrated communication platform.

It is another object of the present invention, wherein the users include buyers, sellers/retailers, organizations and people sharing common interest related to a product or service etc.

It is another object of the present invention, wherein the system facilitates retailers or organizations having a database of information to extend their functionality and accessibility to the web-programmed/application framework thereafter enabling end-users of the framework to avail the information without being required to navigate to multiple web programs/applications or navigate to different websites.

It is another object of the present invention, wherein the web-programmed framework provides software tools that simplifies the process of adapting existing databases of information to the web-application development framework thereby providing the users to port the existing information in a secure and efficient way.

It is another object of the present invention, wherein independent software developers/developer teams could program and deploy software using the framework's software tools. Additionally, software development teams could be setup by retailers/organizations who specialize in design, development, deployment and maintenance of subsystem software that has been built using software tools provided by framework.

It is another object of the present invention, wherein the system with web-programmed framework integrates catalogue display, virtual store customizations etc., and implements other software development frameworks on the web.

It is another object of the present invention, wherein the system provides multitude of virtual stores on the integrated communication platform.

It is another object of the present invention, wherein the virtual store is created by the web-programmed/application framework using web-application development framework.

It is another object of the present invention, wherein every virtual store is unique by itself and different from each other virtual store.

It is another object of the present invention, wherein a smart list application enables the users to organize products, online articles and e-retailers and save them as an individual item to a list.

It is another object of the present invention to provide a system with security, privacy and with user experience.

It is another object of the present invention, the web-application gathers information about users by integrating with social networking site and generates a profile, and said profile is integrated into the web-application development framework.

It is another object of the present invention, the web-application acts as an intermediary that aggregates users' digital activities and provides them with a secure and ubiquitous reserve for personal content.

It is another object of the present invention, wherein recommendation of products and notifications are made based on subscribed items and interests of the user.

It is another object of the present invention wherein the system is accessible from web, Smartphone and also from other upcoming devices and platforms.

### SUMMARY OF INVENTION

Thus according to the basic aspect of the present invention there is provided a system for integrating ecommerce and social networking site on a single web-based platform using web-application comprising:
One or more social networking sites;
One or more ecommerce sites;
One or more processors;
One or more servers; and
One or more content databases,
wherein the web-applications are developed using web-application development frameworks,
wherein the web-application gathers information from social and ecommerce networking sites,
wherein users are connected via an integrated communication platform and link their content databases to the web-application,
wherein the web-application gathers information about users by integrating with social networking site and generates a profile, said profile is integrated into web-application framework,
wherein the users with database of information have accessibility to the web-application framework thereafter enabling end-users of the web-application framework to avail the information without being required to navigate to multiple web-applications or navigate to different websites,
wherein the web-application with its algorithm channelizes user's content and recommends both contextual and relevant information to the user,
wherein the users can develop and deploy web-application using web-application development frameworks,
wherein the system integrates catalogue display, virtual store customizations and implements software development frameworks on the web,
wherein the system provides multitude of unique virtual stores on the integrated communication platform, and
wherein the system provides a smart list application that enables the users to organize products, online articles and e-retailers and to create smart list through the web-application to include interested items.

It is another aspect of the present invention, wherein the users include buyers, sellers/retailers, organizations and people sharing common interest related to a product or service.

It is another aspect of the present invention, wherein the user provides permission to the web-application to access the information and profile to perform ecommerce.

It is another aspect of the present invention, wherein the virtual store is created by web-application framework using web-application development framework.

It is another aspect of the present invention, wherein the virtual store creates an online interface that would enable the users to interact with each other, share information and do activities related to ecommerce, said information required for each virtual store is gathered from one or more sources that include information created by the users.

It is another aspect of the present invention, wherein every virtual store could be developed and deployed onto the web-application framework by software developers independently.

It is another aspect of the present invention, wherein the communication platform gathers primary information about the users directly from sources, said sources include information created by the users.

It is another aspect of the present invention, wherein the smart list application is polymorphic in nature and acts based on the items present in the smart list.

It is another aspect of the present invention, wherein the smart list application provides a two-way communication stream as follows:
communicates with the user and helps the user keep track of items of interest, and
intrinsically enhances the organizing capabilities of one or a group of users.

It is another aspect of the present invention, wherein the smart list functionality and capabilities' permission could be extended to another user or group of users.

It is another aspect of the present invention, wherein the smart list can be modified by authorized user.

It is another aspect of the present invention, wherein recommendation of products and notifications are made based on subscribed items and interests of the user.

It is another aspect of the present invention, wherein the system notifies the user of available updates to items.

### BRIEF DESCRIPTION OF THE DRAWING

FIG. 1: illustrates system according to the present invention.

### DETAILED DESCRIPTION OF THE INVENTION WITH REFERENCE TO THE ACCOMPANING DRAWING

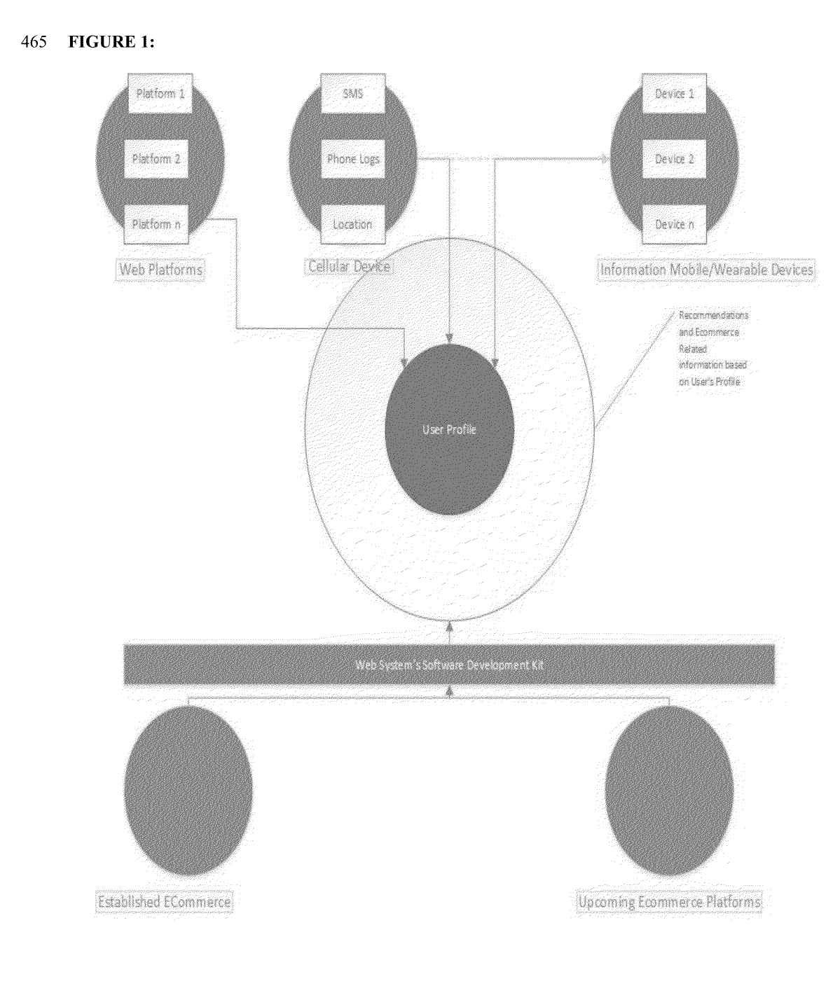

The present invention meets the aforementioned need and other needs by providing a system for integrating e-commerce and social networking site on a single web-based platform wherein web-programs/applications can be developed by using a web-application development framework. Referring to FIG. 1, the system comprises of one or more social networking sites, one or more ecommerce sites, one or more processors, one or more servers and content database which facilitates user to avail required information without navigating to multiple web programs/applications or navigate to different websites. The users are connected via an integrated communication platform and link their content databases to the web-application. The communication platform connects the users via an online interface. The online interface enables the users to interact and share information. The users include buyers, sellers/retailers, organizations and people sharing common interest related to a product or service. The web-application gathers information about the users by integrating with social and ecommerce networking sites and generates a profile; said profile is integrated into the web-application development framework.

The web-application serves as a collection of information for the entire user's personal information. The web-application of the system does the logging of the entire digital footprints of a user by integrating seamlessly with existing social platform the user is actively participating in. The web-application enables its user to discover content by leveraging user's personal preferences and patterns from multiple platforms, and then recommend both contextual and relevant information to the user.

The web-application of the present invention overcomes the existing problem such as, (1) no central place where a user could log all his activities across different platforms; (2) personalization of information is always very limited to one kind of dataset of user; (3) Security and privacy have become major concerns. The web-application provides all the necessities of a bank that exist in the real world, such as security, privacy and easy in accessibility (user experience) of the usage of his or her currency (information). User experience is achieved by satiate mind based on life's memories, experience and information. The web-application is the web age's equivalent to Autobiographies or journals that are prevalent since beginning of humankind User can analyze all his or her past information amassed from various sources, all in one place, thereby eliminating the need to perform cumbersome searches but get airy answers to the general queries on activities of user. The social platforms provide journaling application or timeline where user can store their personal information, but the information is accessed by public, retailers and other organizations. In current aspect, the marketers access timelines and gather information about interested users for their business and thus it is a major problem for privacy concerns. The present invention overcomes the problem by the use of web-application. Retailers or organizations can access the user profile through social networks and may input irrelevant contents in users profile, thus such a problem of insecurity is overcome by the present invention. To solely aggregate and help discover content, the web-application could achieve what other platforms have set to start-to keep a log of person's life and in this process not compromise on security, privacy or seamless user experience. The web-application thus gathers information about user, records and remains safe, secure and always available for its user.

The web-application with its algorithm could enable the user to query on any moment of user's activities with ease. Furthermore with enabling Auto-Biographer mode of the web-application, the algorithm would be able to automatically journal/sum-up a person's day/week period of time in a natural language. Even without a user searching for information, the algorithm could recommend what the user might like.

The system provides web-programmed/application framework such as Play Framework, which is accessible from web, Smartphone and also from other upcoming devices and platforms to build the core platform. It acts as a channel through which information could be stored and made available across platforms, i.e. personal information like text messages and phone logs present in the phone can be synchronized to the present invention and accessed using a web browser. It also facilitates retailers or organizations having a database of information to extend their functionality and accessibility thereby enabling end-users of the framework to avail the information without being required to navigate to multiple web programs/applications or navigate to different websites.

The web-programmed framework utilize software tools for instance Scala that facilitate faster prototyping and developer productivity and also simplify the process of adapting existing databases of information to the web-application development framework thereby providing the users to write highly scalable, concurrent and performing software. Independent software developers or developer teams could program and deploy software using the said framework's software tools. Additionally, software development teams could be setup by retailers or organizations that specialize in design, development, deployment and maintenance of subsystem software that has been built using software tools provided by framework.

The system utilize content database such as PostgreSQL which is designed for high volume environments and has legendary reliability and stability with strong open source community and enterprise backing The present invention requires a flexible infrastructure which is provided by various web services, but not limited to Amazon web services. A prototype not limited to agile methodologies called SEMET kernel that is able to aggregate information from Facebook, twitter and Android is used in the present invention and further, it also performs basic search methodologies.

The system with web-programmed framework integrates catalogue display, virtual store customizations etc., and implements other software development frameworks on the web with multitude of virtual stores on the integrated communication platform. The virtual store is created by the web-programmed/application framework using web-application development framework, thus it fulfills functionality and operational requirements needed, which includes making an online interface that would enable retailers, organizations and users to interact with each other, share information and do activities related to commerce. Every other virtual store has their organizations online activities extended to web programmed framework. Every virtual store is unique by itself and different from each other virtual store. The information required is gathered from one or more sources. The virtual store extends the existing online ecommerce stores onto the integrated communication platform and can be developed and deployed onto web programmed framework by software developers/developer teams independently.

The system provides a smart list application that enables the users to organize products, online articles and e-retailers and save them as an individual item to a list. Moreover, the smart list is explicitly created by the user through the web-application and the interested items can be added to the list, further it provides a two-way communication stream as follows:
communicates with the user and helps user keep track of items of interest, and
enhances the organizing capabilities of one or a group of users

The smart list application is polymorphic in nature and acts based on the items present in the list, thus its functionality and capabilities' permission could be extended to another user or group of users, other than the user who created the list, in which case the authorized user can make modifications to the said list and recommendation of products and notifications are made based on subscribed items and interests of the user. The information required for recommendations is intrinsically gathered from multiple sources, including user generated content of the user's friends, user's interests, subscriptions, etc. Further, the user is notified of available updates to items, including recent activity pertaining to the items by other related users, price variations or new offers provided by the retailer, organization or any new written content published by users/authors.

The system further enables the user to create a profile. Whenever a profile is created by the user, a profile is generated using explicit data given by the user for predictive web analytics; the profile is further processed with the help of implicit information available through patterns of user's social circles and integrated into web-application framework for predictive social-analytics, thus the gathered information is further classified and processed into data. The system acquire permission from the user to gather information from multiple web platforms where the said user is linked and access the said user's profile present in other web platforms. Furthermore, the information obtained is beneficial in predicting the user's activities and provide user with more refined and accurate information that is specific to the user, wherein the user belonging to a specific interest group can be associated with users sharing similar interests and information of interest.

The system thus provides the functionality of gathering content-specific information, establishing communication and helping retailers or organizations understand users and continue the business activities. The system fetches information from within the integrated communication platform and sources from which information is sought, said sources include information created by users, retailers and organizations. The communication platform establishes a channel among retailers and their potential customers to gather primary information in one or more ways directly from the source. The information gathered and present in the communication platform is statistically analyzed and graphically represented for the process of data mining. For illustration, if user wishes to buy products, gives permission to the web-application to access data and profile, to perform ecommerce. A user could discover products, newer products and the shopping experience could change based on these refined profiles. The retailers link their databases to the web-application platform, to refine their products metadata using web-application for better targeting the users. Once purchase is done users could choose with whom and where he would like to share his thoughts on the product.

I claim:

1. A system for integrating ecommerce and social networking site on a single web-based platform using web-application comprising:
One or more social networking sites;
One or more ecommerce sites;
One or more processors;
One or more servers; and
One or more content databases,
wherein the web-applications are developed using web-application development frameworks,
wherein the web-application gathers information from social and ecommerce networking sites,
wherein users are connected via an integrated communication platform and link their content databases to the web-application,
wherein the web-application gathers information about users by integrating with social networking site and generates a profile, said profile is integrated into web-application framework,
wherein the users with database of information have accessibility to the web-application framework thereafter enabling end-users of the web-application framework to avail the information without being required to navigate to multiple web-applications or navigate to different websites,
wherein the web-application with its algorithm channelizes user's content and recommends both contextual and relevant information to the user,
wherein the users can develop and deploy web-application using web-application development frameworks,
wherein the system integrates catalogue display, virtual store customizations and implements software development frameworks on the web,
wherein the system provides multitude of unique virtual stores on the integrated communication platform, and
wherein the system provides a smart list application that enables the users to organize products, online articles and e-retailers and to create smart list through the web-application to include interested items.

2. The system as claimed in claim 1, wherein the users include buyers, sellers/retailers, organizations and people sharing common interest related to a product or service.

3. The system as claimed in claim 2, wherein the user provides permission to the web-application to access the information and profile to perform ecommerce.

4. The system as claimed in claim 1, wherein the virtual store is created by web-application framework using web-application development framework.

5. The system as claimed in claim 4, wherein the virtual store creates an online interface that would enable the users to interact with each other, share information and do activities related to ecommerce, said information required for each virtual store is gathered from one or more sources that include information created by the users.

6. The system as claimed in claim 5, wherein every virtual store could be developed and deployed onto the web-application framework by software developers independently.

7. The system as claimed in claim 1, wherein the communication platform gathers primary information about the users directly from sources, said sources include information created by the users.

8. The system as claimed in claim 1, wherein the smart list application is polymorphic in nature and acts based on the items present in the smart list.

9. The system as claimed in claim 8, wherein the smart list application provides a two-way communication stream as follows:
communicates with the user and helps the user keep track of items of interest, and intrinsically enhances the organizing capabilities of one or a group of users.

10. The system as claimed in claim 9, wherein the smart list functionality and capabilities' permission could be extended to another user or group of users.

11. The system as claimed in claim 10, wherein the smart list can be modified by authorized user.

12. The system as claimed in claim 1, wherein recommendation of products and notifications are made based on subscribed items and interests of the user.

13. The system as claimed in claim 12 notifies the user of available updates to items.
